(19) United States
(12) Patent Application Publication
(10) Pub. No.: US 2021/0297993 A1
(43) Pub. Date: Sep. 23, 2021

(54) METHODS, DEVICES AND COMPUTER READABLE MEDIA FOR UPLINK CHANNEL MEASUREMENT

(71) Applicant: NEC CORPORATION, Tokyo (JP)

(72) Inventors: Fang YUAN, Beijing (CN); Lin LIANG, Beijing (CN); Gang WANG, Beijing (CN)

(73) Assignee: NEC CORPORATION, Tokyo (JP)

(21) Appl. No.: 17/260,436

(22) PCT Filed: Jul. 20, 2018
(86) PCT No.: PCT/CN2018/096538

§ 371 Date: Jan. 14, 2021

(51) Int. Cl. H04W 72/02; H04W 72/04; H04W 80/02; H04L 25/02; H04L 5/00; H04B 7/0456

(52) U.S. Cl. CPC H04W 72/02; H04W 72/046; H04W 72/0446; H04B 7/0456; H04W 80/02; H04L 25/0226; H04L 5/0051; H04W 72/0413

(57) ABSTRACT

Embodiments of the present disclosure relate to methods, devices and computer readable medium for uplink channel measurement. In an embodiment of the present disclosure, a method for uplink channel measurement is performed at a terminal device and the method may include transmitting an uplink control channel carrying a demodulation reference signal in a plurality of slots to a network device with different transmission configurations, and receiving, from the network device, an indication of transmission configuration obtained based on measurements on the demodulation reference signal contained in the uplink control channel transmitted in the plurality of slots.

### FIELD OF THE INVENTION

The non-limiting and exemplary embodiments of the present disclosure generally relate to the field of wireless communication techniques, and more particularly relate to a method, device and computer readable medium for uplink control channel at a terminal device in a wireless communication system, and a method, device and computer readable medium for uplink channel measurement at a network device in a wireless communication system.

### BACKGROUND OF THE INVENTION

This section introduces aspects that may facilitate better understanding of the disclosure. Accordingly, the statements of this section are to be read in this light and are not to be understood as admissions about what is in the prior art or what is not in the prior art.

New radio access system, which is also called as NR system or NR network, is the next generation communication system. In Radio Access Network (RAN) #71 meeting for the third generation Partnership Project (3GPP) working group, study of the NR system was approved. The NR system will consider frequency ranging up to 100 Ghz with an object of a single technical framework addressing all usage scenarios, requirements and deployment scenarios defined in Technical Report TR 38.913, which includes requirements such as enhanced mobile broadband, massive machine-type communications, and ultra-reliable and low latency communications.

As one of important references signals in the wireless communication system, Sounding Reference Signal (SRS) is configured by a base station to support uplink channel measurements for beam management, non-codebook based uplink Multiple-Input Multiple-Output (MIMO) transmission, codebook-based uplink MIMO transmission, etc. However, the SRS may not be configured or triggered during the communication process. This means that there are some cases in which the SRS is not available and thus it will be a challenge to perform uplink channel measurement for MIMO transmission in NR system.

### SUMMARY OF THE INVENTION

In general, example embodiments of the present disclosure provide new solutions for uplink channel measurement in a wireless communication system.

According to a first aspect of the present disclosure, there is provided a method for uplink channel measurement at a terminal device in a wireless communication system. The method may include transmitting an uplink control channel carrying a demodulation reference signal in a plurality of slots to a network device with different transmission configurations, and receiving, from the network device, an indication of transmission configuration obtained based on measurement on the demodulation reference signal contained in the uplink control channel in the plurality of slots.

According to a second aspect of the present disclosure, there is provided a method for uplink channel measurement at a network device in a wireless communication system. The method may be performed at network device. The method may include receiving an uplink control channel carrying a demodulation reference signal from a terminal device in a plurality of slots with different transmission configurations; performing a channel measurement on the demodulation reference signal contained in the uplink control channel in the plurality of slots to obtain a transmission configuration; and transmitting an indication of the transmission configuration to the terminal device.

According to a third aspect of the present disclosure, there is provided a terminal device. The terminal device may comprise a processor and a memory. The memory may be coupled with the processor and having program codes therein, which, when executed on the processor, cause the terminal device to perform operations of the first aspect.

According to a fourth aspect of the present disclosure, there is provided a network device. The network device may comprise a processor and a memory. The memory may be coupled with the processor and have program codes therein, which, when executed on the processor, cause the network device to perform operations of the second aspect.

According to a fifth aspect of the present disclosure, there is provided a computer-readable storage medium with computer program codes embodied thereon, the computer program codes configured to, when executed, cause an apparatus to perform actions in the method according to any embodiment in the first aspect.

According to a sixth aspect of the present disclosure, there is provided a computer-readable storage medium with computer program codes embodied thereon, the computer program codes configured to, when executed, cause an apparatus to perform actions in the method according to any embodiment in the second aspect.

According to a seventh aspect of the present disclosure, there is provided a computer program product comprising a computer-readable storage medium according to the fifth aspect.

According to an eighth aspect of the present disclosure, there is provided a computer program product comprising a computer-readable storage medium according to the eighth aspect.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 illustrates an example Media Access Control Control Element

(MAC CE) structure in the prior art;

FIG. 2 schematically illustrates a physical uplink control channel (PUCCH) transmission solution in the prior art;

FIG. 3 schematically illustrates a flow chart of a method for uplink channel measurement at a terminal device in a wireless communication system according to some embodiments of the present disclosure;

FIG. 4 schematically illustrates an example PUCCH transmission solution according to some embodiments of the present disclosure;

FIG. 5 schematically illustrates an example indication of transmission configuration according to some embodiments of the present disclosure;

FIG. 6 schematically illustrates an example transmission without SRS according to some embodiments of the present disclosure;

FIG. 7 schematically illustrates an example PUCCH transmission solution in a unlicensed band according to some embodiments of the present disclosure;

FIG. 8 schematically illustrates another example PUCCH transmission solution according to some embodiments of the present disclosure;

FIG. 9 schematically illustrates another example indication of transmission configuration according to some embodiments of the present disclosure;

FIG. 10 schematically illustrates another example transmission without SRS according to some embodiments of the present disclosure;

FIG. 11 schematically illustrates a further example PUCCH transmission solution according to some embodiments of the present disclosure;

FIG. 12 schematically illustrates an example MAC CE structure according to some embodiments of the present disclosure;

FIG. 13 schematically illustrates a further indication of transmission configuration according to some embodiments of the present disclosure;

FIG. 14 schematically illustrates a further example transmission without SRS according to some embodiments of the present disclosure;

FIG. 15 schematically illustrates a flow chart of a method for uplink channel measurement at a network device in a wireless communication system according to some embodiments of the present disclosure;

FIG. 16 schematically illustrates a block diagram of an apparatus for uplink channel measurement at a terminal device in a wireless communication system according to some embodiments of the present disclosure;

FIG. 17 schematically illustrates a block diagram of an apparatus for uplink channel measurement at a network device in a wireless communication system according to some embodiments of the present disclosure; and

FIG. 18 schematically illustrates a simplified block diagram of an apparatus 18110 that may be embodied as or comprised in a terminal device like UE, and an apparatus 1820 that may be embodied as or comprised in a network device like gNB as described herein.

### DETAILED DESCRIPTION OF EMBODIMENTS

Hereinafter, the solutions as provided in the present disclosure will be described in details through embodiments with reference to the accompanying drawings. It should be appreciated that these embodiments are presented only to enable those skilled in the art to better understand and implement the present disclosure, not intended to limit the scope of the present disclosure in any manner. For example, features illustrated or described as part of one embodiment may be used with another embodiment to yield still a further embodiment. In the interest of clarity, not all features of an actual implementation are described in this specification.

In the accompanying drawings, various embodiments of the present disclosure are illustrated in block diagrams, flow charts and other diagrams. Each block in the flowcharts or blocks may represent a module, a program, or a part of code, which contains one or more executable instructions for performing specified logic functions, and in the present disclosure, a dispensable block is illustrated in a dotted line. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc.

may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

As used herein, the term “wireless communication network” refers to a network following any suitable wireless communication standards, such as New Radio (NR), Long Term Evolution (LTE), LTE-Advanced (LTE-A), Wideband Code Division Multiple Access (WCDMA), High-Speed Packet Access (HSPA), and so on. The “wireless communication network” may also be referred to as a “wireless communication system.” Furthermore, communications between network devices, between a network device and a terminal device, or between terminal devices in the wireless communication network may be performed according to any suitable communication protocol, including, but not limited to, Global System for Mobile Communications (GSM), Universal Mobile Telecommunications System (UMTS), Long Term Evolution (LTE), New Radio (NR), wireless local area network (WLAN) standards, such as the IEEE 802.11 standards, and/or any other appropriate wireless communication standard either currently known or to be developed in the future.

As used herein, the term “network device” refers to a node in a wireless communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communications. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “communication device”, “terminal”, “user equipment” and “UE” may be used interchangeably.

As yet another example, in an Internet of Things (TOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band intemet of things (NB-IoT) standard. Examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink (DL) transmission refers to a transmission from a network device to UE, and an uplink (UL) transmission refers to a transmission in an opposite direction.

As mentioned above, SRS is one of the important reference signals and is configured by a network device to support uplink channel measurements for beam management, non-codebook based uplink MIMO transmission, codebook-based uplink MIMO transmission, etc. An SRS signal may be transmitted on an SRS resource by using a beam, or a combination of beam and precoder. A beam generally refers to, but not limited to, a wideband analog beamforming applied to for example a phased antenna array with one radio-frequency (RF) chain. A precoder refers to a digital precoding applied to for example multiple antenna ports on multiple RF chains.

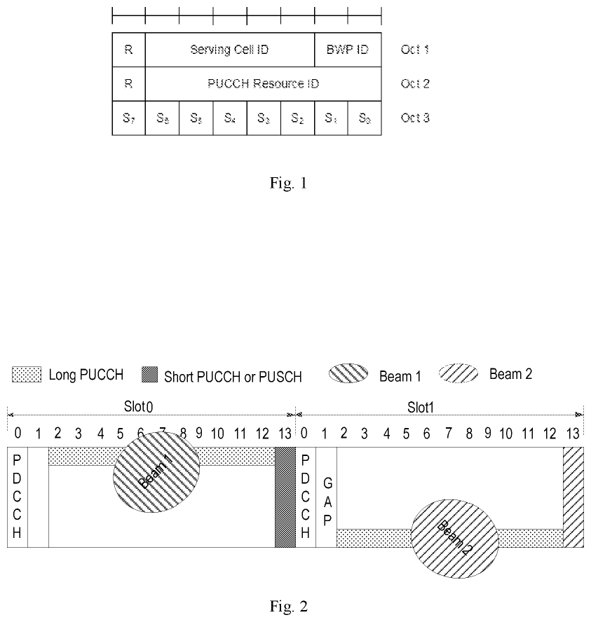

For beam management, a list of PUCCH-spatialRelationshipinfo information elements (IEs) will be configured for each PUCCH by means of a radio resource control (RRC) signaling. The terminal device sends SRS signals with different beams on SRS resources to the network device for the UL channel measurement. The network device activates or deactivates one of PUCCH-spatialRelationshipInfo information elements (IEs) by MAC-CE based on the UL channel measurement result. FIG. 1 schematically illustrates an example structure of MAC CE in the prior art. The MAC CE have three byte each with 8 bits, The first byte contains severing cell identity (ID), bandwidth part (BWP) ID and a reserved bit, the second byte contains PUCCH resource ID and a served bit; and the third byte contains eight bits, S to S7, which are a bitmap used to indicate the selected PUCCH-spatialRelationshipinfo associated with the UL channel measurement result. The MAC CE is transmitted to the terminal device and thus the terminal device could learn the selected PUCCH-spatialRelationshipinfo and in turn learn selected beams for the subsequent UL transmission.

For non-codebook based UL MIMO transmission, the terminal device precodes SRS signals with different precoders on different SRS resources and the network device selects one or more SRS resources based on the channel measurement and indicates the selected SRS resources by means of a SRS Resource Indication (SRI). For illustrative purposes, Table 1 illustrates the definition of SRS for non-codebook based UL MIMO transmission.

TABLE 1
SRI for non-codebook based UL MIMO transmission.

| Field | Value |
|---|---|
| SRS resource indicator if the higher layer parameter txConfig = nonCodebook, where N_{SRS} is the number of configured SRS resources in the SRS resource set. | $⌈ {log}_{2} ( {\sum }_{k = 1}^{min \{ {L}_{max} , {N}_{SRS} \}} ( \begin{matrix}{N}_{SRS} \\ k\end{matrix} ) ) ⌉$ |

Table 1 illustrates the meaning of the SRI filed and how to determine it value. In addition, Table 2 further illustrates an example mapping of the SRI filed to index for non-codebook based Physical Uplink Shared Channel (PUSCH) transmission under N_{SRS}=2,3,4

TABLE 2
SRI indication for non-codebook based PUSCH
transmission Lmax = 2

| | | Bit field | | Bit field | |
|---|---|---|---|---|---|
| | SRI(s) | mapped | SRI(s) | mapped | SRI(s), |
| + | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6-7 | reserved | 6 | 0, 3 |
| | | | | 7 | 1, 2 |
| | | | | 8 | 1, 3 |
| | | | | 9 | 2, 3 |
| | | | | 10-15 | reserved |

In the non-codebook based UL transmission, the network device does not need to select specific codewords based on any codebook but selects the SRS resources based on the channel measurement.

By contrast, for the codebook based UL MIMO, the network device will use a predetermined codebook and select codewords from the codebook as precoders for subsequent UL transmission. Particularly, the terminal device does not precode the SRS with different precoders but transmits the SRS on different antenna ports using different beams on different SRS resources. For UL transmission, the network device selects a beam based on different SRS resources and selects a codeword from the predetermined codebook based on different antenna ports. The beam selection is indicated by a SRI field. For illustrative purposes, Table 3 illustrates the definition of SRS for codebook based PUCCH transmission.

TABLE 3
SRI for codebook based UL MIMO transmission

| Field | Value |
|---|---|
| SRS resource indicator | ┌log₂(N_{SRS})┐ |
| if the higher layer parameter bcConfig = | |
| Codebook where N_{SRS} is the number of | |
| configured SRS resources in the SRS | |
| resource set. | |

Table 3 illustrates the meaning of the SRI filed for codebook based UL MIMO transmission and how to determine it value. In addition, Table 4 further illustrates an example mapping of the SRI filed to index for codebook based PUSCH transmission.

TABLE 4
SRI indication for codebook based PUSCH transmission

| Bit field mapped to index | SRI(s) |
|---|---|
| 0 | 0 |
| 1 | 1 |

However, the SRS may not be configured or activated during the communication process. That means that there are some cases in which the SRS is not available. Therefore, when it requires beam management, non-codebook based UL MIMO, or codebook based UL MIMO, it will be a challenge to perform uplink channel measurement for MIMO transmission in NR system.

In 3GPP technical document R1-1720684, there is proposed a new PUCCH transmission solution. In the document, it was proposed to transmit a Long PUCCH in multiple slots and the long PUCCH in each slot can contain the same information but have different PUCCH resource IDs. FIG. 2 illustrates a diagram of PUCCH transmission as proposed in the document. As illustrated, a long PUCCH is transmitted in both slots but on different beams. By means of multiple transmissions of the long PUCCH, it could achieve a diversity gain.

Embodiments of the present disclosure provide new solutions for uplink channel measurement in a wireless communication to address the problem when the SRS is unavailable. In embodiments of the present disclosure, it proposed to transmit an uplink control channel carrying a demodulation reference signal (DMRS) in a plurality of slots to a network device with different transmission configurations like any of different beams, different antenna ports, different precoders, etc., and the channel measurement is preformed based on the demodulation reference signal contained in the uplink control channel transmitted in the plurality of slots with different transmission configurations. By means of the measurement on the DMRS of the PUCCH transmitted in multiple slots, the network device could perform beam management, non-codebook UL MIMO, codebook UL MIMO without SRS, which further enables the UL MIMO transmission without SRS.

Hereinafter, reference will be further made to accompanying drawings to describe the solutions as proposed in the present disclosure in details. However, it shall be appreciated that the following embodiments are given only for illustrative purposes and the present disclosure is not limited thereto.

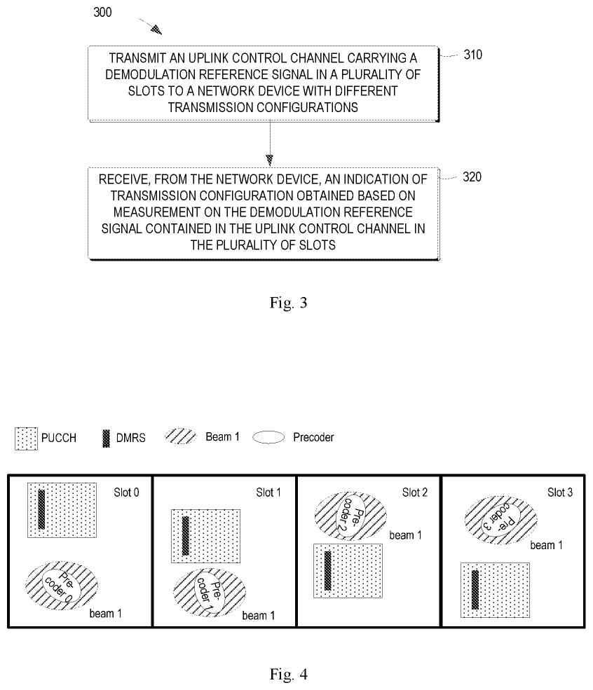

FIG. 3 schematically illustrates a flow chart of a method for uplink channel measurement in a wireless communication system according to some embodiments of the present disclosure. The method 300 can be implemented at a terminal device like UE or any other terminal device.

As illustrated in FIG. 3, in step 310, the terminal device transmits an uplink control channel carrying a DMRS in a plurality of slots to a network device with different transmission configurations. In embodiments of the present disclosure, the uplink control channel like Physical PUCCH will be transmitted repeatedly in the plurality of slots. The PUCCH may be repeated for example 2 times, 4 times, or 8 times, or any other times based on the channel measurement requirements. The PUCCH contains DMRS on which the uplink channel measurement can be performed. The PUCCH can be performed with different transmission configurations such different precoders, different antenna ports, different beams, etc. Based on the PUCCH transmitted in multiple slots with different transmission configurations, the network device could perform channel measurement on DMRS in the PUCCH to obtain transmission configuration which is for subsequent uplink transmission based on the measurement result.

Next, in step 320, the terminal device receives, from the network device, an indication of—transmission configuration, the transmission configuration being obtained based on measurement on the demodulation reference signal contained in the uplink control channel in the plurality of slots.

For better understanding of embodiments of the present disclosure, reference will be made to FIGS. 4 to 14 to describe several examples of the present disclosures. However, it shall be appreciated that these examples are only given for illustration purposes and the present disclosure is not limited thereto.

FIG. 4 schematically illustrates an example PUCCH transmission solution according to some embodiments of the present disclosure, which is particularly applicable to, for example, a non-codebook based UL MIMO. In the illustrated transmission solution, the PUCCH is transmitted four times; however, it shall be appreciated that the present disclosure is not limited thereto; it may also be repeated 2 times, 8 times or any other suitable times.

As illustrated in FIG. 4, the uplink control channel may be precoded with different precoders and transmitted on the same beam in the four slots. In other words, in each of slots 0 to slot 3, PUCCH is transmitted on the same beam, i.e., beam 1, using antenna port index 2000 defined in 3GPP TS38.212 and TS38.211, but the PUCCH in the four slots are precoded with four different rank-one precoders, precoders 0 to 3. In addition, it is possible for the PUCCH to have a predetermined frequency hopping pattern as also illustrated by different frequency locations in FIG. 4.

The network device such as gNB could perform UL channel measurement on DMRS of the PUCCH transmitted in slots 0 to 3. Through the measurement, it may determine one or more DRMSs with better qualities than others and one or more precoders used for the PUCCH in the corresponding slots will be the selected precoders. The transmission configuration regarding the selected precoders can be indicated to the terminal device by means of an indication of transmission configuration. The indication can be carried in an SRI field, which can be interpreted as an index corresponding to the selected precoders.

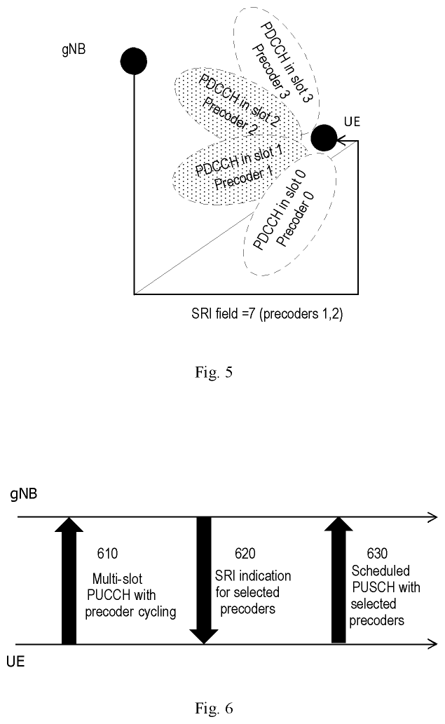

For illustrative purposes, FIG. 5 schematically illustrates an example indication of transmission configuration according to some embodiments of the present disclosure. For the case using 4 slots to repeat the PUCCH illustrated in FIG. 4, the SRI field is an index corresponding to the selected precoders. In such a case, the SRI field “7” could indicate that the precoder 1 and precoder 2 are selected (see Table 2). In other words, the precoders used in slot 1 and slot 2 are selected by the network device.

For illustrative purposes, FIG. 6 further illustrates an example transmission without SRS according to some embodiments of the present disclosure. As illustrated in FIG. 6, in step 610, the terminal device UE sends multi-slot PUCCH with precoder cycling. In other words, the PUCCH is transmitted in a predetermined number of slots with different precoders. Then the network device gNB performs channel measurement on the DMRS contained in the PUCCH and selected one or more precoders. In step 620, the gNB sends an SRI indication for selected precoders via SRI field in downlink control information to inform the UE of the selected precoders. In step 630, the terminal device transmits uplink data on the scheduled physical uplink shared channel (PUSCH) using the selected precoders.

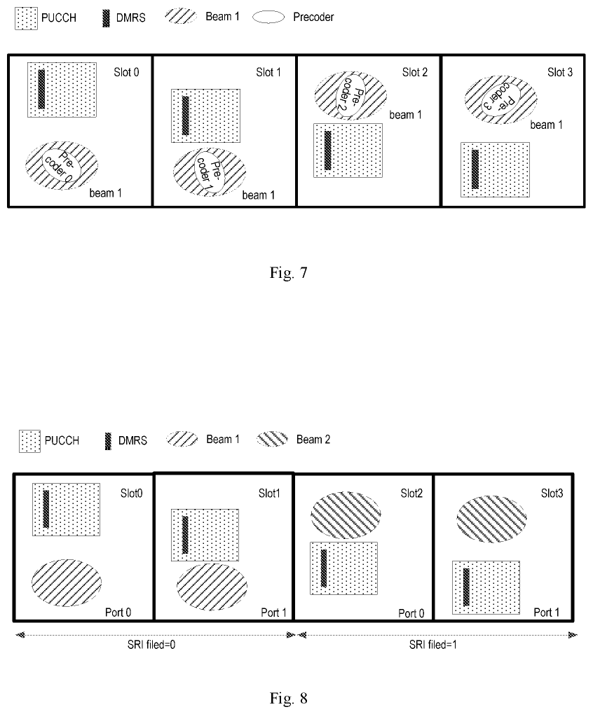

FIG. 7 further schematically illustrates a PUCCH transmission solution in an unlicensed band according to some embodiments of the present disclosure. In FIG. 7, the PUCCH transmission can be performed on the new radio unlicensed band instead of the licensed band. In FIG. 7, the PUCCH is transmitted four times; however, it shall be appreciated that the present disclosure is not limited thereto; it may also be repeated 2 times, 8 times or any other suitable times.

As illustrated in FIG. 7, the uplink control channel may be precoded with different precoders and transmitted on the same beam in the four slots. However, different from that illustrated in FIG. 4, in FIG. 7, the PUCCH is transmitted with another uplink control channel for another terminal device in an interlacing way on a whole unlicensed band in each of slots 0 to 3. Thus, for the NR-U transmission, the channel measurement can be performed on the whole unlicensed band and thus transmission configurations determined based on the channel measurement result are wideband, which will be more accurate since it can reflect the condition on the whole unlicensed band.

FIG. 8 schematically illustrates another example PUCCH transmission solution according to some embodiments of the present disclosure, which is particularly applicable to, for example, a codebook based UL MIMO. In the illustrated transmission solution, the PUCCH is transmitted four times; however, it shall be appreciated that the present disclosure is not limited thereto; it may also be repeated 2 times, 8 times or any other suitable times.

As illustrated in FIG. 8, the four slots are divided into for example two slot groups, which can be indicated respective by SRI field=0 and SRI field=1. The first slot group includes slot 0 and slot 1 and the second slot group includes slot 2 and slot 3. For the two different slot groups, the PUCCH will be transmitted with the two different beams, respectively. Within each of the slot groups, the PUCCH will be transmitted with the same beam, but through two different antenna ports. That is to say, in the first slot group, the PUCCH is transmitted on beam 1 while in the second group, the PUCCH is transmitted on beam 2; in each of the first and second slot groups, the PUCCH is transmitted through port 0 in the first slot, slot 0 or slot 2, and through port 1 in in the following second slot, slot 1 or slot 3. In addition, it is also possible for the PUCCH to have a predetermined frequency hopping pattern as also illustrated by different frequency locations in FIG. 8.

The network device such as gNB could perform UL channel measurement on DMRS of the PUCCH transmitted in slots 0 to 3. Through the measurement, it may determine which slot group has a better quality than the other and the beam used in the corresponding slot group will be selected for UL MIMO transmission. At the same time, the network device will select suitable codewords from a predetermined codebook for the uplink channel concatenated by two antenna ports in the slot group.

The transmission configuration regarding the selected beam and codewords can be indicated to the terminal device by means of a first indication and a second indication to indicate the selected beams and the selected codewords respectively. The first indication can be carried in for example an SRI field which is an index corresponding to the selected beam and the second indication can be carried in for example a transmit precoding matrix indicator (TPMI).

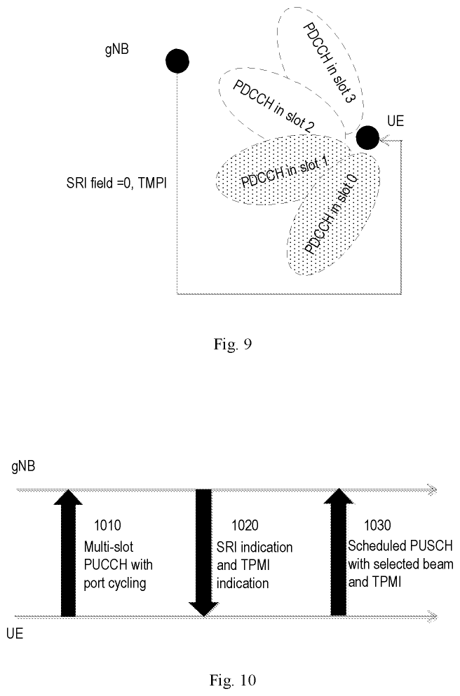

For illustrative purposes, FIG. 9 schematically illustrates an example indication of transmission configuration according to some embodiments of the present disclosure. For the case dividing 4 slots into 2 slot groups illustrated in FIG. 8, the SRI field may have one bit which could have two different values each corresponding to one slot group. For example, the SRI field “0” indicate the first slot group and the SRI field “1” indicate the second slot group. In such a case, the SRI field “0” could indicate that beam 1 used in the first slot group including slot 0 and slot 1 are selected. The TPMI is used to indicate the codewords selected for the uplink channel concatenated by two antenna ports in slot 0 and slot 1.

For illustrative purposes, FIG. 10 further illustrates another example transmission without SRS according to some embodiments of the present disclosure. As illustrated in FIG. 10, in step 1010, the terminal device UE sends multi-slot PUCCH with port cycling. In other words, the PUCCH is transmitted in at least two slot groups with different beams and in each of the slot groups, and the PUCCH is transmitted through different antenna ports. Then, the network device gNB performs channel measurement on the DMRS contained in the PUCCH and selected one or more beams and codewords for the uplink channel concatenated by different antenna ports in a slot group. In step 1020, the gNB sends an SRI indication for the selected one or more beams via SRI field in downlink control information and an uplink precoder information for the selected codewords via TPMI field. In step 1030, the terminal device transmit on physical uplink shared channel using selected one or more beam and the codewords as uplink precoders.

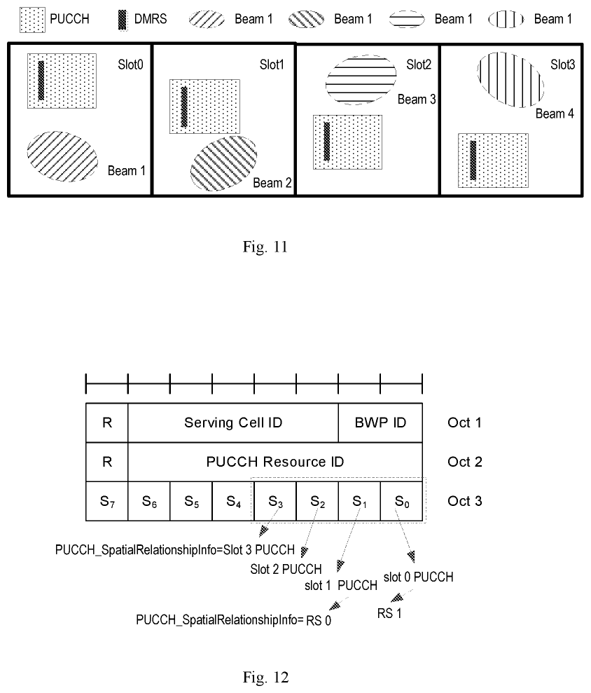

FIG. 11 schematically illustrates a further example PUCCH transmission solution according to some embodiments of the present disclosure, which is particularly applicable to for example the beam management. In the illustrated transmission solution, the PUCCH is transmitted four times; however, it shall be appreciated that the present disclosure is not limited thereto; it may also be repeated 2 times, 8 times or any other suitable times.

As illustrated in FIG. 11, in each of the four slots, the PUCCH will be transmitted with four different beams, beams 1 to 4 respectively. In addition, it is possible for the PUCCH to have a predetermined frequency hopping pattern as also illustrated by different frequency locations in FIG. 11.

The network device such as gNB could perform UL channel measurement on DMRS of the PUCCH transmitted in slots 0 to 3. Through the measurements, it may determine one or more slot having better qualities than others and the beam used for the corresponding slot will be selected for UL transmission. The transmission configuration regarding the selected beam can be indicated to the terminal device by means of an indication of transmission configuration. The indication can be carried in for example a MAC CE.

FIG. 12 schematically illustrates an example MAC CE structure according to some embodiments of the present disclosure. The structure of the MAC CE is exactly same as that in the prior art, but bits S0 to S7 can be used to indicate the selected beam. For example, for the example solution illustrated in FIG. 11, S0 to S3 can be used to indicate the information associated with different slots when a PUCCH is repeated four times. By means of the MAC CE, the terminal device could learn the selected slots and in turn learn beams corresponding to the selected slots and use them for the subsequent UL transmission.

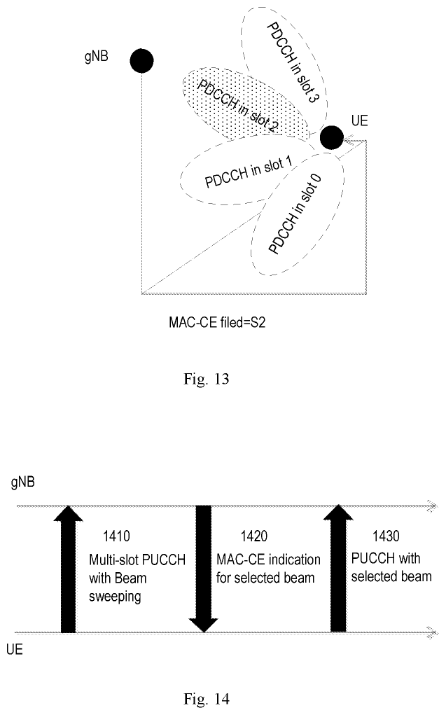

For illustrative purposes, FIG. 13 schematically illustrates an example indication of transmission configuration according to some embodiments of the present disclosure. As illustrate in FIG. 13, the MAC CE activates S2, which means the DMRS of PUCCH in slot 2 has the best quality and thus beam 3 used for the PUCCH in this slot is selected.

For illustrative purposes, FIG. 14 further illustrates a further example transmission without SRS according to some embodiments of the present disclosure. As illustrated in FIG. 14, in step 1410, the terminal device UE sends multi-slot PUCCH with beam sweeping. In other words, the PUCCH is transmitted in four slots with four different beams. Then, the network device gNB performs channel measurement on the DMRS contained in the PUCCH and selected one or more of the four beams. In step 1420, the gNB sends an MAC CE indication for the selected beams. In step 1030, the terminal device transmit physical uplink control channel with the selected beams.

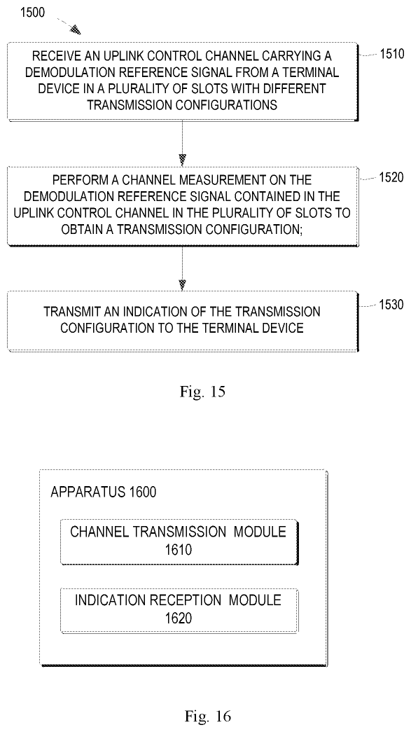

Hereinafter, the solution for uplink channel measurement at the terminal device is described with reference to FIGS. 3 to 14 and next reference will be made to FIG. 15 to describe the solution for uplink channel measurement at the network device

FIG. 15 schematically illustrates a flow chart of a method for uplink channel measurement at a network device in a wireless communication system according to some embodiments of the present disclosure. The method 1500 can be performed at the network device such as gNB or any other network device.

As illustrated in FIG. 15, in step 1510, the network device receiving an uplink control channel carrying a demodulation reference signal from a terminal device in a plurality of slots with different transmission configurations. In embodiments of the present disclosure, the uplink control channel like PUCCH will be transmitted repeatedly in the plurality of antenna slots. The PUCCH may be repeated for example 2 times, 4 times, or 8 times, or any other times based on the channel measurement requirements. The PUCCH contains DMRS on which the uplink channel measurement can be performed. The PUCCH can be transmitted with different transmission configurations such different precoders, different antenna ports, different beams, etc.

In step 1520, the network device performs a channel measurement on the demodulation reference signal contained in the uplink control channel in the plurality of slots to obtain a transmission configuration. Particularly, the network device may for example measure the signal quality of the DMRS and determines the DMRS with a better quality from the DMRS of the PUCCH transmitted in the plurality of slots and thus determine the suitable transmission configurations.

In step 1530, the network device may transmit an indication of the transmission configuration to the terminal device.

In some embodiments of the present disclosure, the network device may receive the uplink control channel precoded with different precoders on the same beam in the plurality of slots. In other words, all PUCCHs in the plurality of slots are received on the same beam, but the PUCCH is precoded with different procedors in different slots. The network device may measure the channel quality based on the received DMRS and determine the DRMS with for example better qualities. In such a case, the indication of transmission configuration may be an indication indicating one or more selected precoders for subsequent uplink transmissions. The indication of transmission configuration may be carried by, for example, the sounding reference signal resource indication (SRI). For some details about these embodiments, reference could be made to FIGS. 4 to 6 and descriptions made with regard thereto.

In some embodiments of the present disclosure, the network device may receive the uplink control channel with another uplink control channel for another terminal device in an interlacing way on a whole unlicensed band in each of the plurality of slots. In other words, the solution of the present disclosure can be used in transmission on unlicensed band like NR-U, to achieve accurate channel measurement. For details about these embodiments, reference could be made to FIG. 7 and descriptions made with regard thereto.

In some embodiments of the present disclosure, the plurality of slots may be divided into at least two slot groups, the network device may receive the uplink control channel in the at least two slot groups with at least two different beams, and in each of the at least two slot groups, the uplink control channel transmitted through a plurality of antenna ports may be received on the same beam. Based on the channel qualities measured on different slot groups, the network device may determine one of them with the best quality, which means the beam used in the slot group is selected. Next, the network device selects codewords for respective slots in the selected slot group, which means codewords are selected for respective antenna ports. In such a case, the network device may transmit a first indication of transmission configuration indicating one or more selected beams and a second indication of transmission configuration indicating selected codewords respectively for the plurality of antenna ports to the terminal device. The first indication of transmission configuration may be carried by for example a sounding reference signal resource indication (SRI). The second indication of channel transmission result may be carried by for example a transmitted precoding matrix indicator (TPMI). For details about these embodiments, reference could be made to FIGS. 8 to 10 and descriptions made with regard thereto.

In some embodiments of the present disclosure, the network device may receive the uplink control channel on a plurality of different beams in the plurality of slots. The network device may perform the channel measurement on DMRS in the uplink channel in the plurality of slots and determines which one or more DMRS have a better quality. In such a case, the network device may transmit an indication of transmission configuration indicating one or more selected beams. The indication of transmission configuration may be carried by, for example, a MAC CE. For details about these embodiments, reference could be made to FIGS. 11 to 13 and descriptions made with regard thereto.

In some embodiments of the present disclosure, the network device may receive the uplink control channel in the plurality of slots with a predetermined frequency hopping pattern.

Hereinabove, various aspects of uplink channel measurement on the network device are described in brief hereinbefore with reference to FIG. 15. However, it can be understood that operations at the network device are corresponding to those at the terminal device and thus for some details of operations, one may refer to description with reference to FIGS. 3 to 14.

FIG. 16 schematically illustrates a block diagram of an apparatus for uplink channel measurement in a wireless communication system according to some embodiments of the present disclosure. The apparatus 1600 can be implemented at a terminal device or any other terminal device.

As illustrated in FIG. 16, the apparatus 1600 may include a channel transmission module 1610 and an indication reception module 1620. The channel transmission module 1610 may be configured to transmit an uplink control channel carrying a demodulation reference signal in a plurality of slots to a network device with different transmission configurations. The indication reception module 1620 may be configured to receive, from the network device, an indication of transmission configuration obtained based on measurement on the demodulation reference signal contained in the uplink control channel in the plurality of slot.

In some embodiments of the present disclosure, the channel transmission module 1610 may be further configured to transmit the uplink control channel precoded with different precoders on a same beam in the plurality of slots. In these embodiments of the present disclosure, the indication reception module 1620 may be configured to receive an indication of transmission configuration indicating one or more selected precoders.

In some embodiments of the present disclosure, the indication of transmission configuration may be carried by a sounding reference signal resource indication (SRI).

In some embodiments of the present disclosure, the channel transmission module 1610 may be further configured to transmit the uplink control channel with another uplink control channel for another terminal device in an interlacing way on a whole unlicensed band in each of the plurality of slots.

In some embodiments of the present disclosure, the plurality of slots may be divided into at least two slot groups, and the channel transmission module 1610 may be further configured to transmit the uplink control channel in the at least two slot groups with at least two different beams, and in each of the at least two slot groups, the uplink control channel being transmitted on a same beam through a plurality of antenna ports. In these embodiments of the present disclosure, the indication reception module 1620 may be configured to receive a first indication of transmission configuration indicating one or more selected beams and a second indication of transmission configuration indicating selected codewords respectively for the plurality of antenna ports.

In some embodiments of the present disclosure, the first indication of transmission configuration may be carried by a sounding reference signal resource indication (SRI), and/or the second indication of channel transmission result may be carried by a transmit precoding matrix indicator (TPMI).

In some embodiments of the present disclosure, the channel transmission module 1610 may be further configured to transmit the uplink control channel on a plurality of different beams in the plurality of slots. In these embodiments of the present disclosure, the indication reception module 1620 may be configured to receive an indication of transmission configuration indicating one or more selected beams.

In some embodiments of the present disclosure, the indication of transmission configuration is carried by an MAC CE.

In some embodiments of the present disclosure, the channel transmission module 1610 may be further configured to transmit the uplink control channel in the plurality of slots in a predetermined frequency hopping pattern.

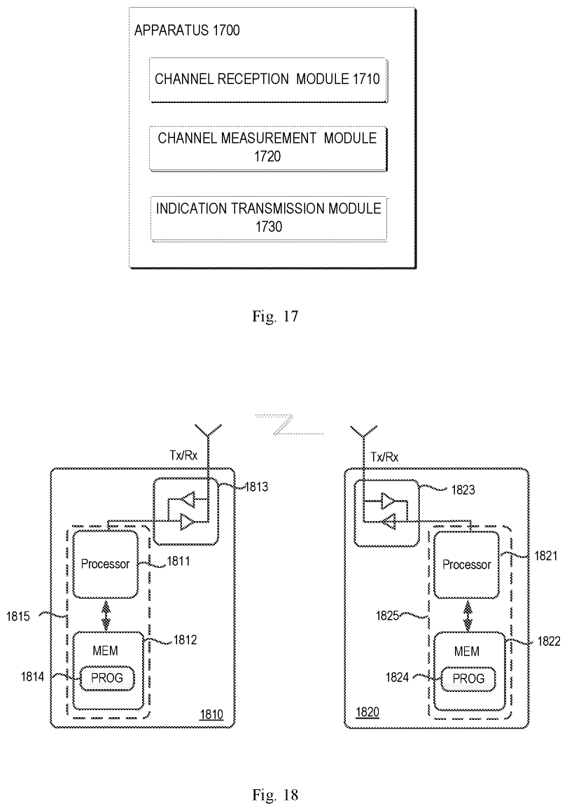

FIG. 17 schematically illustrates a block diagram of an apparatus for uplink channel measurement in a wireless communication system according to some embodiments of the present disclosure. The method 1700 can be implemented at the network device such as gNB or any other network device.

As illustrated in FIG. 17, the apparatus 1700 may include a channel reception module 1710, a channel measurement module 1720, and an indication transmission module 1730. The channel reception module 1710 may be configured to receive an uplink control channel carrying a demodulation reference signal from a terminal device in a plurality of slots with different transmission configurations. The channel measurement module 1720 may be configured to perform a channel measurement on the demodulation reference signal contained in the uplink control channel in the plurality of slots to obtain a transmission configuration. The indication transmission module 1730 may be configured to transmit an indication of the transmission configuration to the terminal device.

In some embodiments of the present disclosure, the channel reception module 1710 may be configured to receive the uplink control channel precoded with different precoders on the same beam in the plurality of slots, and the indication transmission module 1730 may be configured to transmit an indication of transmission configuration indicating one or more selected precoders.

In some embodiments of the present disclosure, the indication of transmission configuration is carried by the sounding reference signal resource indication (SRI).

In some embodiments of the present disclosure, the channel reception module 1710 may be configured to receive the uplink control channel with another uplink control channel for another terminal device in an interlacing way on a whole unlicensed band in each of the plurality of slots.

In some embodiments of the present disclosure, the plurality of slots may be divided into at least two slot groups, and present disclosure, the channel reception module 1710 may be configured to receive the uplink control channel in the at least two slot groups with at least two different beams, and in each of the at least two slot groups, the uplink control channel transmitted through a plurality of antenna ports being received on the same beam. In these embodiments of the present disclosure, the indication transmission module 1730 may be configured to transmit a first indication of transmission configuration indicating one or more selected beams and a second indication of transmission configuration indicating selected codewords respectively for the plurality of antenna ports.

In these embodiments of the present disclosure, the first indication of transmission configuration is carried by a sounding reference signal resource indication (SRI), and/or wherein the second indication of channel transmission result is carried by a transmit precoding matrix indicator (TPMI).

In some embodiments of the present disclosure, the channel reception module 1710 may be configured to receive the uplink control channel on a plurality of different beams in the plurality of slots. In these embodiments of the present disclosure, the indication transmission module 1730 may be configured to transmit an indication of transmission configuration indicating one or more selected beams.

In some embodiments of the present disclosure, the indication of transmission configuration is carried by an MAC CE.

In some embodiments of the present disclosure, the channel reception module 1710 may be configured to receive the uplink control channel in the plurality of slots with a predetermined frequency hopping pattern.

Hereinabove, apparatuses 1600 and 1700 are described with reference to FIGS. 16 and 17 in brief. It can be noticed that the apparatuses 1600 and 1700 may be configured to implement functionalities as described with reference to FIGS. 3 to 15. Therefore, for details about the operations of modules in these apparatuses, one may refer to those descriptions made with respect to the respective steps of the methods with reference to FIGS. 3 to 15.

It is further noticed that components of the apparatuses 1600 and 1700 may be embodied in hardware, software, firmware, and/or any combination thereof. For example, the components of apparatuses 1600 and 1700 may be respectively implemented by a circuit, a processor or any other appropriate selection device.

Those skilled in the art will appreciate that the aforesaid examples are only for illustration not limitation and the present disclosure is not limited thereto; one can readily conceive many variations, additions, deletions and modifications from the teaching provided herein and all these variations, additions, deletions and modifications fall the protection scope of the present disclosure.

In addition, in some embodiment of the present disclosure, apparatuses 1600 and 1700 may include at least one processor. The at least one processor suitable for use with embodiments of the present disclosure may include, by way of example, both general and special purpose processors already known or developed in the future. Apparatuses 1600 and 1700 may further include at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause apparatuses 1600 and 1700 to at least perform operations according to the method as discussed with reference to FIGS. 3 to 15 respectively.

FIG. 18 schematically illustrates a simplified block diagram of an apparatus 1810 that may be embodied as or comprised in a terminal device like UE, and an apparatus 1820 that may be embodied as or comprised in a network device like gNB as described herein.

The apparatus 1810 comprises at least one processor 1811, such as a data processor (DP) and at least one memory (MEM) 1812 coupled to the processor 1811. The apparatus 1810 may further include a transmitter TX and receiver RX 1813 coupled to the processor 1811, which may be operable to communicatively connect to the apparatus 1820. The MEM 1812 stores a program (PROG) 1814. The PROG 1814 may include instructions that, when executed on the associated processor 1811, enable the apparatus 1810 to operate in accordance with embodiments of the present disclosure, for example method 300. A combination of the at least one processor 1811 and the at least one MEM 1812 may form processing means 1815 adapted to implement various embodiments of the present disclosure.

The apparatus 1820 comprises at least one processor 1821, such as a DP, and at least one MEM 1822 coupled to the processor 1821. The apparatus 1820 may further include a suitable TX/ RX 1823 coupled to the processor 1821, which may be operable for wireless communication with the apparatus 1810. The MEM 1822 stores a PROG 1824. The PROG1 1824 may include instructions that, when executed on the associated processor 2181, enable the apparatus 1820 to operate in accordance with the embodiments of the present disclosure, for example to perform method 1500. A combination of the at least one processor 1821 and the at least one MEM 1822 may form processing means 1825 adapted to implement various embodiments of the present disclosure.

Various embodiments of the present disclosure may be implemented by computer program executable by one or more of the processors 1811, 1821, software, firmware, hardware or in a combination thereof

The MEMs 1812 and 1822 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 1811 and 1821 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method for uplink channel measurement, comprising:
at a terminal device,
transmitting an uplink control channel carrying a demodulation reference signal in a plurality of slots to a network device with different transmission configurations; and
receiving, from the network device, an indication of transmission configuration obtained based on measurement on the demodulation reference signal contained in the uplink control channel in the plurality of slots.

2. The method of claim 1, wherein the transmitting an uplink control channel further comprises:
transmitting the uplink control channel precoded with different precoders on a same beam in the plurality of slots, and
wherein the receiving an indication of transmission configuration comprises receiving an indication of transmission configuration indicating one or more selected precoders.

3. The method of claim 1, wherein the indication of transmission configuration is carried by a sounding reference signal resource indication (SRI).

4. The method of claim 1, wherein the transmitting an uplink control channel further comprises:
transmitting the uplink control channel with another uplink control channel for another terminal device in an interlacing way on a whole unlicensed band in each of the plurality of slots.

5. The method of claim 1, wherein the plurality of slots are divided into at least two slot groups, and the transmitting an uplink control channel further comprises:
transmitting the uplink control channel in the at least two slot groups with at least two different beams, and in each of the at least two slot groups, the uplink control channel being transmitted on a same beam through a plurality of antenna ports, and
wherein the receiving an indication of transmission configuration comprises receiving a first indication of transmission configuration indicating one or more selected beams and a second indication of transmission configuration indicating selected codewords respectively for the plurality of antenna ports.

6. The method of claim 5, wherein the first indication of transmission configuration is carried by a sounding reference signal resource indication (SRI), and/or wherein the second indication of channel transmission result is carried by a transmitted precoding matrix indicator (TPMI).

7. The method of claim 1, wherein the transmitting an uplink control channel further comprises:
transmitting the uplink control channel on a plurality of different beams in the plurality of slots, and
wherein the receiving an indication of transmission configuration comprises receiving an indication of transmission configuration indicating one or more selected beams.

8. The method of claim 1, wherein the indication of transmission configuration is carried by a media access control control element (MAC CE).

9. The method of claim 1, wherein the transmitting an uplink control channel further comprises
transmitting the uplink control channel in the plurality of slots in a predetermined frequency hopping pattern.

10. A method for uplink channel measurement, comprising:
at a network device,
receiving an uplink control channel carrying a demodulation reference signal from a terminal device in a plurality of slots with different transmission configurations;
performing a channel measurement on the demodulation reference signal contained in the uplink control channel in the plurality of slots to obtain a transmission configuration; and
transmitting an indication of the transmission configuration to the terminal device.

11. The method of claim 10, wherein the receiving an uplink control channel further comprises:
receiving the uplink control channel precoded with different precoders on the same beam in the plurality of slots, and
wherein the transmitting an indication of transmission configuration comprises transmitting an indication of transmission configuration indicating one or more selected precoders.

12. The method of claim 10, wherein the indication of transmission configuration is carried by a sounding reference signal resource indication (SRI).

13. The method of claim 10, wherein the transmitting an uplink control channel further comprises:
receiving the uplink control channel with another uplink control channel for another terminal device in an interlacing way on a whole unlicensed band in each of the plurality of slots.

14. The method of claim 10, wherein the plurality of slots are divided into at least two slot groups, and the receiving an uplink control channel further comprises:
receiving the uplink control channel in the at least two slot groups with at least two different beams, and in each of the at least two slot groups, the uplink control channel transmitted through a plurality of antenna ports being received on the same beam; and
wherein the transmitting an indication of transmission configuration comprises transmitting a first indication of transmission configuration indicating one or more selected beams and a second indication of transmission configuration indicating selected codewords respectively for the plurality of antenna ports.

15. The method of claim 14, wherein the first indication of transmission configuration is carried by a sounding reference signal resource indication (SRI), and/or wherein the second indication of channel transmission result is carried by a transmitted precoding matrix indicator (TPMI).

16. The method of claim 10, wherein the receiving an uplink control channel further comprises:
receiving the uplink control channel on a plurality of different beams in the plurality of slots, and
wherein the transmitting an indication of transmission configuration comprises transmitting an indication of transmission configuration indicating one or more selected beams.

17. The method of claim 10, wherein the indication of transmission configuration is carried by a media access control control element (MAC CE).

18. The method of claim 10, wherein the receiving an uplink control channel further comprises
receiving the uplink control channel in the plurality of slots with a predetermined frequency hopping pattern.

19. A terminal device, comprising:
at least one processor; and
at least one memory including computer program codes;
the at least one memory and the computer program codes are configured to, with the at least one processor, cause the terminal device at least to perform the method of claim 1.

20-22. (canceled)
